(19) United States
(12) Patent Application Publication
(10) Pub. No.: US 2026/0116493 A1
(43) Pub. Date: Apr. 30, 2026

(54) DISC BRAKE BITE POINT ADJUSTMENT ASSEMBLY

(71) Applicant: Fox Factory, Inc., Duluth, GA (US)

(72) Inventor: Bill Becker, Aptos, CA (US)

(21) Appl. No.: 18/933,138

(22) Filed: Oct. 31, 2024

(51) Int. Cl. B62L 3/02; F16D 65/72

(52) U.S. Cl. CPC B62L 3/023; F16D 65/72

(57) ABSTRACT

A disc brake master cylinder bite point adjustment assembly is provided. A bite point adjustment knob is mounted on the top of a master cylinder reservoir housing which allows a rider to set a brake lever position to a bite point that the brake lever feels solid to the rider. The bite point is adjusted by changing an axial direction stopping point of the master cylinder piston when the brake lever is released. The rotatable bite point adjustment knob includes multiple detent positions for the rider to engage.

### BACKGROUND OF THE INVENTION

### Technical Field

This invention relates generally to disc brake master cylinder assembly and more particularly to a disc brake master cylinder assembly having bite point adjustment.

### State of the Art

Some bikes, including mountain bikes, have disc brake master cylinders with a bite point adjustment that is difficult to use. The bite point of a disc brake master cylinder is the point at which a brake pedal or lever feels solid and the brake pads have contacted the disc rotors, i.e., how far the brake pedal or lever needs to travel. Generally, the feeling between different bite points is hard to adjust.

Accordingly, disc brake master cylinder bite point adjustment is needed which is easy to use and which covers a wide range of user preferences.

### SUMMARY OF THE INVENTION

An embodiment includes a disc brake master cylinder bite point adjustment assembly comprising: a master cylinder reservoir housing having a lower portion and an upper portion; a bite point adjustment knob provided on the upper portion of the master cylinder reservoir housing; a bite point adjustment cam body extending from the bite point adjustment knob; an axially extending lower cam portion of the bite point adjustment cam body extending downward from the bite point adjustment knob and into the lower portion of the master cylinder reservoir housing; and a plurality of detent positions provided about the axially extending lower cam portion configured to provide the bite point adjustment knob with a plurality of corresponding bite point adjustment positions.

A spring biased ball detent may be provided within the bite point adjustment cam body. A plurality of detent recesses may be formed within the master cylinder reservoir housing and cooperate with the spring biased ball detent in order to provide the plurality of detent positions for the bite point adjustment knob. The plurality of detent positions may comprise at least six distinct detent positions. A travel limiting rib may be provided adjacent the bite point adjustment knob in order to prevent the bite point adjustment knob from rotating beyond the plurality of detent positions.

A brake lever may extend from the master cylinder reservoir housing and a brake lever reach adjustment screw may be provided to adjust a position of the brake lever relative to a handlebar grip. An axial shaft portion may extend upwardly from the bite point adjustment cam body to receive the bite point adjustment knob thereon and wherein a set screw secures the bite point adjustment knob to the axial shaft portion.

A master cylinder piston may be slidably received within a master cylinder portion formed within the lower portion of the master cylinder reservoir housing. A coil spring may bias the master cylinder piston toward a resting position with a first end portion of the master cylinder piston in positive engagement with the axially extending lower cam portion. A U-cup seal may be provided about a second end portion opposite the first end portion of the master cylinder piston. A master cylinder reservoir may be provided within the master cylinder reservoir housing and wherein a master cylinder reservoir transfer port provides communication between an interior of the master cylinder portion and an interior of the master cylinder reservoir. A variable axial distance is provided between the U-cup seal and the master cylinder reservoir transfer port. A bite point adjustment cam profile may be provided on the axially extending lower cam portion of the bite point adjustment cam body and adjusts the variable axial distance upon rotation of the bite point adjustment knob.

A push rod may be interconnected with the first end portion of the master cylinder piston via a pivotal ball and socket joint assembly.

Another embodiment includes a method of adjusting a disc brake master cylinder bite point adjustment assembly, the method comprising: providing a bite point adjustment knob on an upper portion of a master cylinder reservoir housing; extending a bite point adjustment cam body from the bite point adjustment knob; providing an axially extending lower cam portion on the bite point adjustment cam body; extending the lower cam portion downward from the bite point adjustment knob and into a lower portion of the master cylinder reservoir housing; providing a plurality of detent positions about the axially extending lower cam portion; configuring the bite point adjustment knob with a plurality of corresponding bite point adjustment positions; and rotating the bite point adjustment knob to selectively position the bite point adjustment knob with one position of the plurality of corresponding bite point adjustment positions.

The method may further comprise forming a plurality of detent recesses within the master cylinder reservoir housing and cooperating with the spring biased ball detent in order to provide the plurality of detent positions for the bite point adjustment knob. The plurality of detent positions may comprise at least six distinct detent positions. The method may further comprise providing a travel limiting rib adjacent the bite point adjustment knob in order to prevent the bite point adjustment knob from rotating beyond the plurality of detent positions.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a is a perspective view of a disc brake master cylinder assembly according to an embodiment;

FIG. 2 is a perspective view of a bite point adjustment knob according to an embodiment;

FIG. 3 is a sectional view of a disc brake master cylinder assembly according to an embodiment;

FIG. 4 is a plan bottom view of a bite point adjustment cam body according to an embodiment.

FIG. 5 is a sectional view of a disc brake master cylinder assembly according to an embodiment; and

FIG. 6 is a flow chart depicting a method of adjusting a disc brake master cylinder bite point adjustment assembly according to an embodiment.

### DETAILED DESCRIPTION OF EMBODIMENTS OF THE INVENTION

As discussed above, embodiments of the present invention relate to a disc brake master cylinder bite point adjustment assembly. The bite point of a disc brake is the point at which a brake pedal or lever feels solid and the brake pads have contacted the disc rotors. The bite point adjustment is external to the disc brake master cylinder assembly and no tools are required.

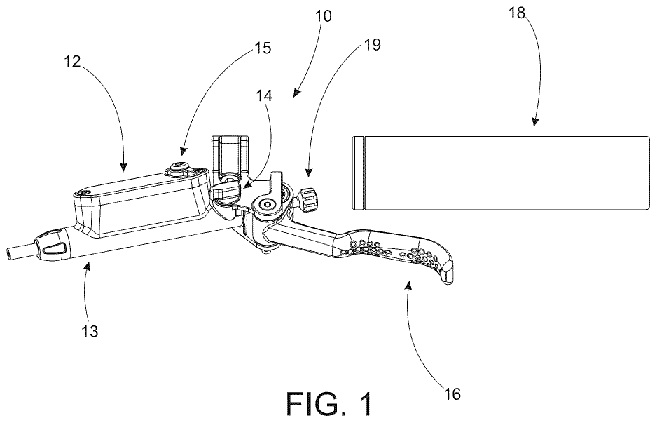

In FIG. 1, a disc brake master cylinder bite point adjustment assembly 10 is provided with a master cylinder reservoir housing 12 having a lower portion 13 and an upper portion 15. A bite point adjustment knob 14 is rotatably mounted on upper portion 15 of master cylinder reservoir housing 12. Bite point adjustment knob 14 is provided with a plurality of selectable positions. A brake lever 16 is provided to operate disc brake master cylinder bite point adjustment assembly 10. The disc brake master cylinder bite point adjustment assembly 10 is configured to couple with a handlebar (not shown) in proximity to a handlebar grip 18 that is provided at a handlebar's end (not shown) A brake lever reach adjustment screw 19 is also provided to adjust the position of brake lever 16 relative to handlebar grip 18.

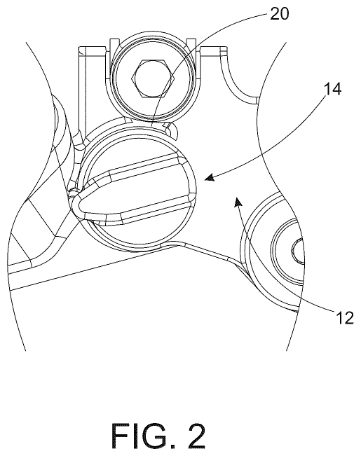

In FIG. 2, bite point adjustment knob 14 is directly mounted to master cylinder reservoir housing 12 to be rotatable relative to master cylinder reservoir housing 12. A travel limiting rib 20 is provided adjacent to bite point adjustment knob 14 in order to limit the rotational movement of bite point adjustment knob 14. In one embodiment, bite point adjustment knob 14 may rotate about 210 degrees. In other embodiments, bite point adjustment knob 14 may rotate more than about 210 degrees and less than about 360 degrees. In another embodiment (not shown), a rib may be provided on bite point adjustment knob 14 and extend below bite point adjustment knob 14 and into a recess provided in master cylinder reservoir housing 12.

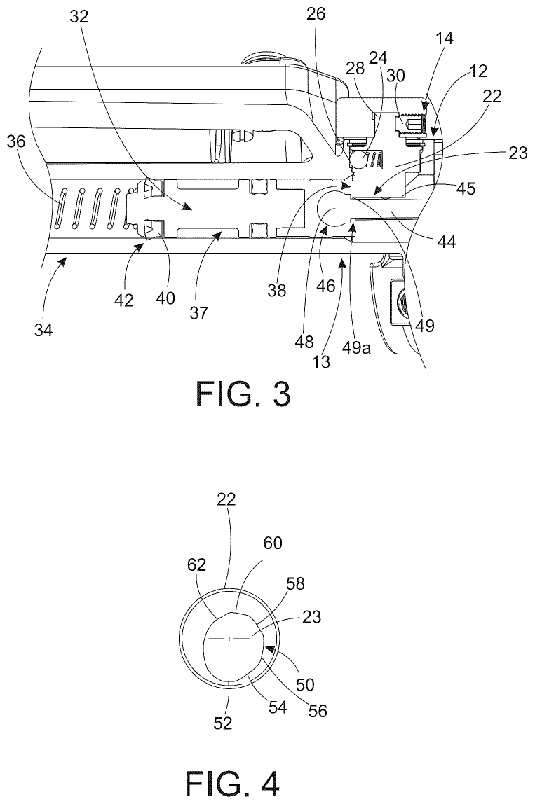

In FIG. 3, bite point adjustment cam body 22 extends below bite point adjustment knob 14. Bite point adjustment cam body 22 is provided with axially extending lower cam portion 23. Axially extending lower cam portion 23 extends axially downward from bite point adjustment cam body 22 toward lower portion 13 of master cylinder reservoir housing 12.

As shown in FIGS. 1 and 2 from a top view of master cylinder reservoir housing 12, bite point adjustment knob 14 is positioned to be centered on master cylinder reservoir housing 12 so that no torque is generated by a preload force of master cylinder piston 32 (see FIG. 3) which may cause bite point adjustment cam body 22 to move from its chosen position. Axially extending lower cam portion 23 contacts first end portion 38 of master cylinder piston 32 and also has clearance 45 with pushrod 44.

Spring-biased ball detent 24 is provided within bite point adjustment cam body 22. Plurality of detent recesses 26 (one of which is shown) are formed in master cylinder reservoir housing 12 in order to present a plurality of corresponding detent positions to a rider when rotating the bite point adjustment knob 14.

An axial shaft portion 28 extends upwardly from bite point adjustment cam body 22. A set screw 30 secures bite point adjustment knob 14 to axial shaft portion 28. Master cylinder piston 32 is slidably received within master cylinder portion 34 formed within the lower portion 13 of the master cylinder reservoir housing 12. A coil spring 36 biases master cylinder piston 32 towards its resting position 37. Master cylinder piston 32 with first end portion 38 positively engages the axially extending lower cam portion 23 when master cylinder piston 32 is in its resting position 37.

A U-cup seal 40 is provided about a second end portion 42 of master cylinder piston 32. Second end portion 42 is provided on an opposite end of the master cylinder piston 32 from the first end portion 38. The coil spring 36 engages the second end portion 42 of the master cylinder piston 32.

Push rod 44 is interconnected with the first end portion 38 of the master cylinder piston 32 via a pivotal ball and socket joint assembly 46. A ball portion 48 of pivotal ball and socket joint assembly 46 is provided with a shoulder portion 49. A clearance 49a is provided between the shoulder portion 49 of the push rod 44 and the axially extending lower cam portion 23. The clearance 49a allows the push rod 44 to go through an angular sweep from a top planar view as the brake lever 16 goes through a full kinematic stroke. If the brake lever 16 is pulled excessively in a crash, the shoulder portion 49 engages the axially extending lower cam portion 23 and is prevented from shifting outwardly beyond the master cylinder piston 32.

Axially extending lower cam portion 23 prevents pushrod 44 removal from pivotal ball and socket joint assembly 46. Pushrod 44 in master cylinder reservoir housing 12 is retained within master cylinder portion 34 by being press-fit into the pivotal ball and socket joint assembly 46.

In FIG. 4, bite point adjustment cam profile 50 is provided on the axially extending lower cam portion 23 of the bite point adjustment cam body 22. The bite point adjustment cam profile 50 has a plurality of detent positions (six detent positions 52, 54, 56, 58, 60 and 62) with a plurality of detent heights, generally each increasing about 0.44 mm. The bite point adjustment cam profile 50 may also have more or less than the six detent positions shown in FIG. 4. Bite point adjustment cam profile 50 may have about a +/−3 degree dwell angle (i.e., constant cam height) and is timed with spring biased ball detent 24 which reacts or responds to plurality of detent recesses 26 provided in master cylinder reservoir housing 12.

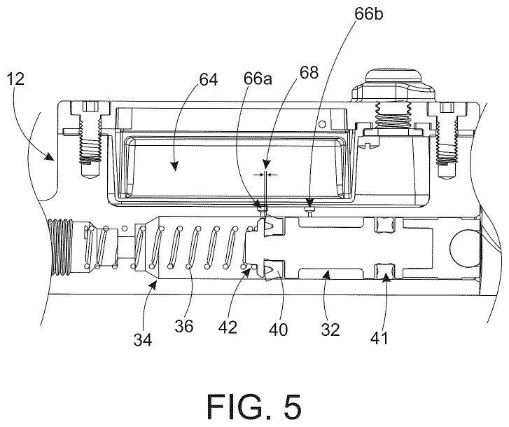

In FIG. 5, master cylinder reservoir 64 is provided within the master cylinder reservoir housing 12. A first master cylinder reservoir transfer port 66a provides communication between an interior of the master cylinder portion 34 and an interior of the master cylinder reservoir 64. A second master cylinder reservoir transfer port 66b is provided between the first master cylinder reservoir transfer port 66a and a quad seal 41 provided on the master cylinder piston 32. The second master cylinder reservoir transfer port 66b allows air to bleed out and fluid to flow in the region between the U-cup seal 40 and the quad seal 41.

As shown in FIG. 5, variable axial distance 68 is provided between the U-cup seal 40 on second end portion 42 of the master cylinder piston 32 and the first master cylinder reservoir transfer port 66a. The bite point adjustment cam profile 50 of the axially extending lower cam portion 23 of the bite point adjustment cam body 22 adjusts the variable axial distance 68 generally from about 0.3 mm to about 2.5 mm in about 0.44 mm increments in a plurality of detent positions. A bite point is adjusted by changing an axial direction stopping point of master cylinder piston 32 within master cylinder portion 34. When brake lever 16 is released, coil spring 36 biases master cylinder piston 32 toward its resting position 37 in engagement with axially extending lower cam portion 23.

The bite point adjustment cam profile 50 having a plurality of detent positions (52, 54, 56, 58, 60 and 62) enables the rider to select a bite point that is suitable to the rider's preference. The bite point is adjusted by rotating bite point adjustment knob 14 to change the variable axial distance 68 with the brake released. When the stopping point of U-cup seal 40 is close to first master cylinder reservoir transfer port 66a, the brake lever 16 will have a shortened lever movement to a bite point. If bite point adjustment knob 14 is rotated to increase the variable axial distance 68, the brake lever 16 will have a lengthened lever movement to the bite point.

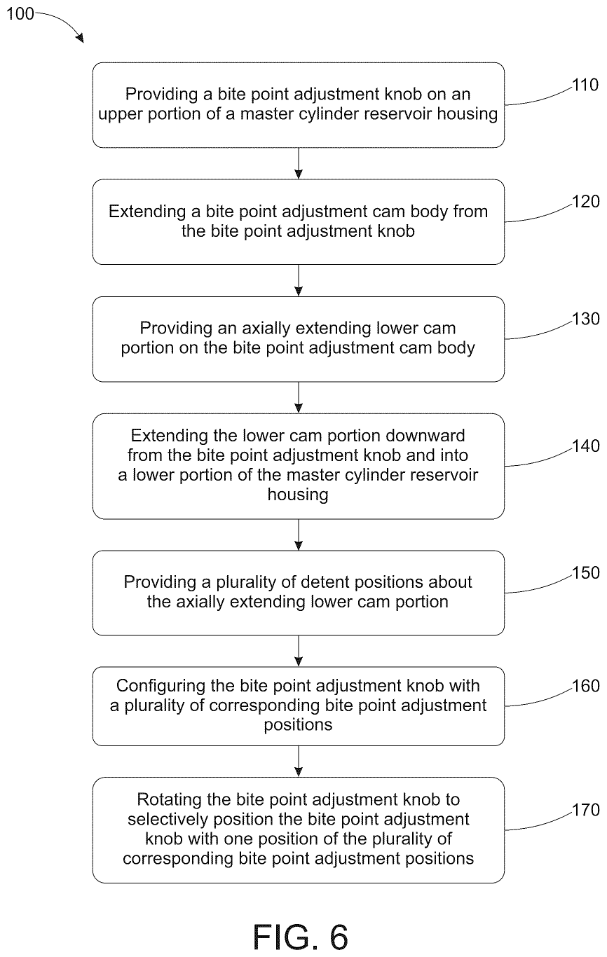

Referring to the drawings, FIG. 6 depicts a method 100 of adjusting a disc brake master cylinder bite point adjustment assembly, the method comprising: providing a bite point adjustment knob on an upper portion of a master cylinder reservoir housing [110]; extending a bite point adjustment cam body from the bite point adjustment knob [120]; providing an axially extending lower cam portion on the bite point adjustment cam body [130]; extending the lower cam portion downward from the bite point adjustment knob and into a lower portion of the master cylinder reservoir housing [140]; providing a plurality of detent positions about the axially extending lower cam portion [150]; configuring the bite point adjustment knob with a plurality of corresponding bite point adjustment positions [160]; and rotating the bite point adjustment knob to selectively position the bite point adjustment knob with one position of the plurality of corresponding bite point adjustment positions [170].

The method 100 further comprises providing a spring biased ball detent within the bite point adjustment cam body. The method also further comprises forming a plurality of detent recesses within the master cylinder reservoir housing and cooperating with the spring biased ball detent in order to provide the plurality of detent positions for the bite point adjustment knob. The plurality of detent positions comprises at least six distinct detent positions. In addition, the method further comprises providing a travel limiting rib adjacent the bite point adjustment knob in order to prevent the bite point adjustment knob from rotating beyond the plurality of detent positions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A disc brake master cylinder bite point adjustment assembly comprising:
a master cylinder reservoir housing having a lower portion and an upper portion;
a bite point adjustment knob provided on the upper portion of the master cylinder reservoir housing;
a bite point adjustment cam body extending from the bite point adjustment knob;
an axially extending lower cam portion of the bite point adjustment cam body extending downward from the bite point adjustment knob and into the lower portion of the master cylinder reservoir housing; and
a plurality of detent positions provided about the axially extending lower cam portion configured to provide the bite point adjustment knob with a plurality of corresponding bite point adjustment positions.

2. The disc brake master cylinder bite point adjustment assembly of claim 1, wherein a spring biased ball detent is provided within the bite point adjustment cam body.

3. The disc brake master cylinder bite point adjustment assembly of claim 2, wherein a plurality of detent recesses are formed within the master cylinder reservoir housing and cooperate with the spring biased ball detent in order to provide the plurality of detent positions for the bite point adjustment knob.

4. The disc brake master cylinder bite point adjustment assembly of claim 3, wherein the plurality of detent positions comprises at least six distinct detent positions.

5. The disc brake master cylinder bite point adjustment assembly of claim 1, wherein a travel limiting rib is provided adjacent the bite point adjustment knob in order to prevent the bite point adjustment knob from rotating beyond the plurality of detent positions.

6. The disc brake master cylinder bite point adjustment assembly of claim 1, wherein a brake lever extends from the master cylinder reservoir housing and a brake lever reach adjustment screw is provided to adjust a position of the brake lever relative to a handlebar grip.

7. The disc brake master cylinder bite point adjustment assembly of claim 1, wherein an axial shaft portion extends upwardly from the bite point adjustment cam body to receive the bite point adjustment knob thereon and wherein a set screw secures the bite point adjustment knob to the axial shaft portion.

8. The disc brake master cylinder bite point adjustment assembly of claim 1, wherein a master cylinder piston is slidably received within a master cylinder portion formed within the lower portion of the master cylinder reservoir housing.

9. The disc brake master cylinder bite point adjustment assembly of claim 8, wherein a coil spring biases the master cylinder piston toward a resting position with a first end portion of the master cylinder piston in positive engagement with the axially extending lower cam portion.

10. The disc brake master cylinder bite point adjustment assembly of claim 9, wherein a U-cup seal provided about a second end portion opposite the first end portion of the master cylinder piston.

11. The disc brake master cylinder bite point adjustment assembly of claim 10, wherein a master cylinder reservoir is provided within the master cylinder reservoir housing and wherein a master cylinder reservoir transfer port provides communication between an interior of the master cylinder portion and an interior of the master cylinder reservoir.

12. The disc brake master cylinder bite point adjustment assembly of claim 11, wherein a variable axial distance is provided between the U-cup seal and the master cylinder transfer port.

13. The disc brake master cylinder bite point adjustment assembly of claim 12, wherein a bite point adjustment cam profile is provided on the axially extending lower cam portion of the bite point adjustment cam body and adjusts the variable axial distance upon rotation of the bite point adjustment knob.

14. The disc brake master cylinder bite point adjustment assembly of claim 9, wherein a push rod is interconnected with the first end portion of the master cylinder piston via a pivotal ball and socket joint assembly.

15. The disc brake master cylinder bite point adjustment assembly of claim 14, wherein the first end portion of the master cylinder piston is configured to contact the axially extending lower cam portion when the master cylinder piston is in the resting position.

16. The disc brake master cylinder bite point adjustment assembly of claim 14, wherein a ball portion of the pivotal ball and socket joint assembly is provided with a shoulder portion configured to positively engage the axially extending lower cam portion when a brake lever is pulled excessively.

17. A method of adjusting a disc brake master cylinder bite point adjustment assembly, the method comprising:
providing a bite point adjustment knob on an upper portion of a master cylinder reservoir housing;
extending a bite point adjustment cam body from the bite point adjustment knob;
providing an axially extending lower cam portion on the bite point adjustment cam body;
extending the axially extending lower cam portion downward from the bite point adjustment knob and into a lower portion of the master cylinder reservoir housing;
providing a plurality of detent positions about the axially extending lower cam portion;
configuring the bite point adjustment knob with a plurality of corresponding bite point adjustment positions; and
rotating the bite point adjustment knob to selectively position the bite point adjustment knob with one position of the plurality of corresponding bite point adjustment positions.

18. The method of claim 17, further comprising providing a spring biased ball detent within the bite point adjustment cam body.

19. The method of claim 18, further comprising forming a plurality of detent recesses within the master cylinder reservoir housing and cooperating with the spring biased ball detent in order to provide the plurality of detent positions for the bite point adjustment knob.

20. The method of claim 19, wherein the plurality of detent positions comprises at least six distinct detent positions.

21. The method of claim 17, further comprising providing a travel limiting rib adjacent the bite point adjustment knob in order to prevent the bite point adjustment knob from rotating beyond the plurality of detent positions.
